(19) United States
(12) Patent Application Publication
(10) Pub. No.: US 2026/0369295 A1
(43) Pub. Date: Nov. 19, 2026

(54) AUDIO SCENE ANALYSIS BASED ON AUDIO CONTENT TYPE IDENTIFICATION

(71) Applicant: HARMAN INTERNATIONAL INDUSTRIES, INCORPORATED, Stamford, CT (US)

(72) Inventors: Yadati Naga PRAMOD, Bengaluru (IN); Amod Jai Ganesh ANANDKUMAR, Bangalore (IN); Spoorthi GE, Bengaluru (IN); Anusha Manjunatha HEGDE, Karnataka (IN); Avilash JAIN, Bangalore (IN); Raymond LUI KA MAN, Hong Kong (CN); Kadagattur Gopinatha SRINIDHI, Novi, MI (US)

(21) Appl. No.: 19/132,184

(22) PCT Filed: Dec. 28, 2023
(86) PCT No.: PCT/US2023/086184

§ 371 Date: May 22, 2025

(30) Foreign Application Priority Data
Dec. 30, 2022 (IN) 202241077075

(51) Int. Cl. G10L 25/51; G10L 15/02; G10L 15/04; G10L 25/78

(52) U.S. Cl. CPC G10L 25/51; G10L 15/02; G10L 15/04; G10L 25/78

(57) ABSTRACT

Audio scene analysis based on audio content type identification include receiving audio data; segmenting the audio data into a plurality of audio frames; extracting one or more audio features from the plurality of audio frames; classifying each of the plurality of audio frames to generate audio classification predictions for the plurality of audio frames based on the one or more features; determining an audio type for a current audio frame of the plurality of audio frames based on the audio classification predictions for the plurality of audio frames within a context window; determining one or more audio settings based on the audio type; processing the audio data for the current audio frame using the one or more audio settings; and outputting the processed audio data using one or more loudspeakers.

### CROSS-REFERENCE TO RELATED APPLICATIONS

This application claims the priority of co-pending Indian patent application titled “AUDIO SCENE ANALYSIS,” filed on Dec. 30, 2022, and having application No. 202241077075. The subject matter of this related application is hereby incorporated herein by reference.

### BACKGROUND

### Field of the Various Embodiments

The embodiments of the present disclosure relate generally to audio engineering and, more specifically, to dynamic audio scene analysis based on audio content type identification.

### Description of the Related Art

The progression of audio technology has been marked by a series of step-by-step enhancements that have progressively refined user interaction and auditory experience. Conventional audio systems were predominantly static, providing a uniform audio settings regardless of the type or nature of the audio content. This approach offered limited flexibility to cater to the diverse range of audio that listeners encounter, from the nuanced lows and highs of a classical symphony to the varied acoustics of a live sporting event. In multimedia entertainment, where a single stream can combine dialogue, sound effects, and a musical score, these static systems lacked the ability to preserve the clarity and intended impact of each audio element, often resulting in a diluted or imbalanced overall sound. This limitation is particularly evident in environments where audio plays a pivotal role in user engagement, such as in video games, virtual reality scenarios, or movies, where the inability to adjust audio settings in real-time could interfere with immersion and lessen enjoyment. The introduction of surround sound systems was a significant step forward, as it began to place users at the center of a more enveloping sound field. However, even with these systems, the lack of dynamic adaptability meant that users often had to manually adjust settings for different types of content-a process that could be both cumbersome and disruptive.

The diversification of audio and video content accessible to consumers, especially with the proliferation of streaming platforms, has accentuated the demand for audio systems that can smartly adjust the outputs to align with the content type. The expectation is that audio systems should not only recognize different types of content while playing but also adapt the audio profiles accordingly without delay. For instance, when a user switches from a podcast to an action movie, the audio system should automatically transition from emphasizing spoken word clarity to highlighting the dynamic range and spatial effects suitable for high-energy scenes. Similarly, while listening to a live concert recording, the audio system could enhance the sense of space and audience ambiance, thereby transporting the listener to the venue. These adjustments would ideally occur in real-time, tracking content shifts within a unified stream, such as a movie that intersperses dialogue, soundtracks, and sound effects, ensuring that each element is audibly distinct and contributes to a cohesive auditory narrative. This intelligent responsiveness is particularly useful in interactive media, such as video games, where the audio landscape can change instantaneously according to the player's actions. In such applications, the audio system's ability to rapidly adapt can significantly impact the user's engagement and immersion, making the difference between a good and an exceptional auditory experience.

Conventional audio systems face notable challenges. One drawback is that conventional audio systems frequently depend on metadata tagged by content creators to guide the adjustment of audio settings. This metadata can include information about the genre, intended audio balance, and even specific cues for audio effects. However, the reliability of this approach is contingent on the thoroughness and accuracy with which the metadata is crafted, which can vary significantly from one content piece to another. In some cases, the metadata can be too generic or not finely tuned to capture the subtleties of the audio track, such as the low-frequency rumble of an approaching storm in a thriller or the delicate reverb in a live jazz recording that gives jazz recording a club-like feel.

Another drawback is the expectation that users will manually intervene to adjust audio settings based on preference is an assumption that overlooks the convenience of modern media consumption habits. Many listeners prefer a hands-off experience, where listeners can immerse themselves in the content without the interruption of having to fiddle with settings. This is particularly relevant when the listener is engaged in other activities, such as driving, exercising, or cooking, where the act of adjusting is not just inconvenient but can also be unsafe or impossible. User intervention also assumes a level of audio expertise that the average listener does not often possess. For example, while watching an action movie, a user often does not know how to adjust the audio system to ensure that dialogue is not drowned out by the soundtrack or sound effects.

Yet another drawback is that the classification of audio content, particularly in scenarios where multiple audio elements are present simultaneously, remains a challenge for current audio systems. Current audio systems can falter when faced with such intricate audio landscapes, where, for instance, a piece of dialogue is interwoven with a musical score or the ambient noise of a bustling cityscape. When these audio systems misidentify the primary audio component, the resulting adjustments to the audio settings can be counterproductive. A system that mistakenly identifies the background music as the main element can enhance the musical experience but at the cost of muffling the actors' voices, making it difficult for viewers to understand the dialogue.

Still another drawback is that silent segments within audio content pose an additional challenge. The transitions into and out of silence are often handled poorly, with conventional audio systems failing to smoothly adjust the audio settings. This can lead to abrupt changes in the audio output, which can be noticeable and potentially disruptive to the listening experience.

As the foregoing illustrates, what is needed in the art is an advanced audio scene analysis system that can dynamically recognize and adapt to different audio content types, including the treatment of silence.

### SUMMARY

In various embodiments, a computer-implemented method includes receiving audio data; segmenting the audio data into a plurality of audio frames; extracting one or more audio features from the plurality of audio frames; classifying each of the plurality of audio frames to generate audio classification predictions for the plurality of audio frames based on the one or more features; determining an audio type for a current audio frame of the plurality of audio frames based on the audio classification predictions for the plurality of audio frames within a context window; determining one or more audio settings based on the audio type; processing the audio data for the current audio frame using the one or more audio settings; and outputting the processed audio data using one or more loudspeakers.

Further embodiments provide, among other things, non-transitory computer-readable storage media storing instructions for implementing the method set forth above, as well as a system configured to implement the method set forth above.

At least one technical advantage of the disclosed techniques relative to the prior art is that, with the disclosed techniques, automatic adaptation of audio settings for dynamically changing audio scenes are possible without metadata tagging. The techniques further allows for the changing of audio settings when it is impractical or unsafe for a user to adjust the audio settings in real time. The disclosed techniques further accurately classify complex audio scenes with multiple overlapping audio types, making contextually appropriate adjustments to enhance the overall listening experience without causing abrupt changes in the audio settings that would disrupt the listening experience. Further, the disclosed techniques smoothly transition into and out of periods of silence. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system, configured to implement one or more aspects of the various embodiments;

FIG. 2 is a block diagram of the audio scene analyzer included in the computing device of FIG. 1 processing audio data, according to various embodiments;

FIG. 3 is a block diagram of the audio type classifier included in the audio scene analyzer of FIG. 2 processing extracted features, according to various embodiments;

FIG. 4 is a block diagram of the contextual scene detector included in the audio scene analyzer of FIG. 2, according to various embodiments;

FIG. 5 illustrates an example of audio data that is analyzed, according to various embodiments;

FIG. 6 is a flow diagram of method steps for audio scene analysis according to various embodiments; and

FIG. 7 is a flow diagram of method steps for determining the context of an audio scene according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

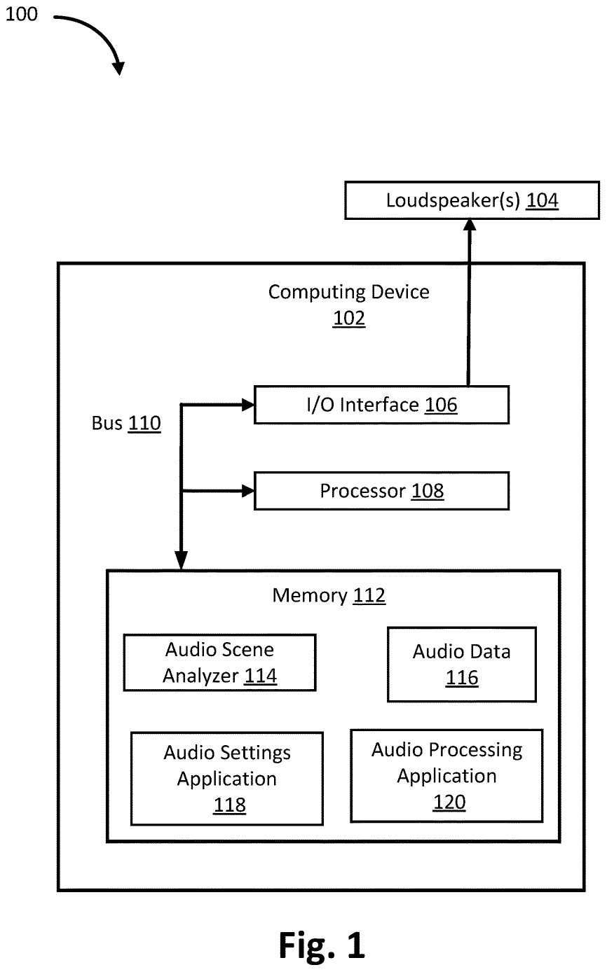

FIG. 1 is a block diagram of a computing system 100 configured to implement one or more aspects of the various embodiments. As shown, computing system 100 includes, without limitation, a computing device 102 and one or more loudspeaker(s) 104. Computing device 102 includes, without limitation, an I/O interface 106, a processor 108, a bus 110, and memory 112. Memory 112 includes, without limitation, an audio scene analyzer 114, audio data 116, audio setting application 118, and an audio processing application 120. In some embodiments, computing system 100 is incorporated into an audio device, such as an audio player, audio/video player, media player, smart phone, tablet, laptop computer, desktop computer, an in-vehicle system, and/or the like.

In operation, the computing device 102 uses audio scene analyzer 114 to continuously assess and classify audio content. Audio input (not shown) can be received through I/O interface 106 and is stored in memory 112 as audio data 116, which can include various types of audio scenes such as dialogue, music, environmental noise, and/or the like. Audio scene analyzer 114 processes audio data 116 to determine audio scene type. Based on the determined audio scene type, audio settings application 118 configures the parameters for processing audio output based on determined audio scene type. The audio settings are then applied by audio processing application 120, which adjusts audio data 116 to enhance certain characteristics such as clarity for dialogue, depth for music, and/or the like, corresponding to the determined audio scene. The resulting audio is then transmitted to the loudspeaker(s) 104, providing a listening experience that adapts in real time to the audio content being played.

The loudspeaker(s) 104 produce the audio output that is to be heard by the user. The loudspeaker(s) 104 are coupled to the computing device 102 via I/O interface 106. For instance, the audio processing application 120 generates the audio signals and sends these audio signals to the loudspeaker(s) 104. In some embodiments, the loudspeaker(s) 104 include any type of loudspeaker, such as dynamic or moving-coil loudspeakers, planar magnetic loudspeakers, electrostatic loudspeakers, and/or the like.

I/O interface 106 facilitates communication between computing device 102 and other external systems including the loudspeaker(s) 104. For example, audio input can be received through the I/O interface 106, such as from a separate media device (not shown) and/or a media streaming service. I/O interface 106 can include any technically feasible type of interface, such as a Universal Serial Bus (USB) interface, a Bluetooth interface an optical audio interface, one or more network interfaces, and/or the like.

Processor 108 performs various computational tasks during operation of computing device 120. Processor 108 is any technically feasible form of processing device configured to process data and execute program code. Processor 108 can include, for example, and without limitation, a system-on-chip (SoC), a central processing unit (CPU), a graphics processing unit (GPU), an application-specific integrated circuit (ASIC), a digital signal processor (DSP), a field-programmable gate array (FPGA), a multi-core processor, or a combination of multiple processing units, such as a CPU configured to operate in conjunction with a GPU and/or a DSP.

Interconnect bus 110 connects I/O interface 106, processor 108, memory 112, and any other components of computing device 102. Interconnect bus 110 facilitates the flow of information and commands between the components of computing device 102. Interconnect bus 110 can be any technically feasible type of bus system including a serial bus, a parallel bus, and/or the like.

Memory 112 includes one or more memory modules. In some embodiments, each of the one more memory modules is a random-access memory (RAM) module, a flash memory unit, or any other type of memory unit or combination thereof. Memory 112 stores information, such as instructions and/or data, for various programs and applications to be executed by processing unit(s) 112. While executing the programs and applications, processing unit(s) 112 are configured to read from memory 112 and write to memory 112. In various embodiments, memory 112 includes non-volatile memory, such as read only memory (ROM), such as flash memory and/or the like.

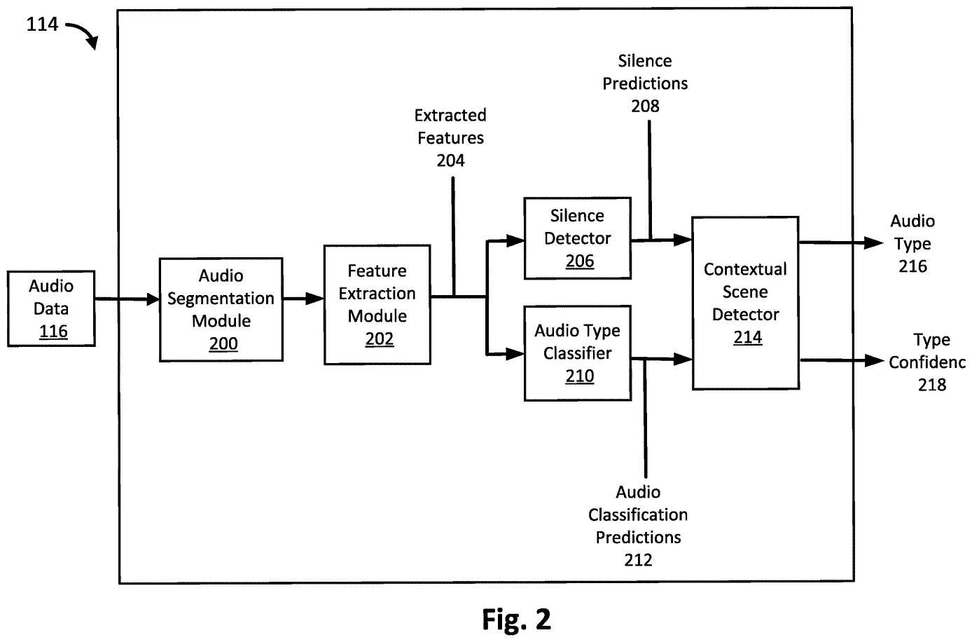

Audio scene analyzer 114 analyzes audio data 116 to help enhance the playback of audio data 116 to one or more users. Audio scene analyzer 114 segments audio data 116 into frames. Audio scene analyzer 114 then processes each segment to extract one or more features of the audio data 116 in that segment. Audio scene analyzer 114 then classifies each frame to determine a type of audio for that frame, such as dialogue, music, action, silence, and/or the like. In some examples, audio scene analyzer also includes separate techniques for detecting silence and detecting the type of audio. Audio scene analyzer 114 then uses a history of the types of audio for the frames and confidence scores of the types of audio to determine the audio scene type. The audio scene type is then provided to audio settings application 118. Audio scene analyzer 114 is described in further detail below in FIGS. 2-5.

In some embodiments, audio scene analyzer 114 includes machine learning algorithms, such as Convolutional Neural Networks (CNNs) and/or the like, which recognize patterns within the frequency spectrum of audio frames and identify the structured elements of music, Recurrent Neural Networks (RNNs) utilizing Long Short-Term Memory (LSTM) architectures and/or the like, which process the temporal sequence of audio data 116 to identify the various audio scene types.

Audio data 116, stored within memory 112, includes a record of the audio content processed by the computing system 100. In various embodiments, audio data 116 is either previously stored in memory 112 or continuously streamed to the computing device 102 via I/O interface 106. Audio data 116 includes a sequence of audio frames. In various embodiments, each audio frame stored in audio data 116 includes characteristics of the input audio within a corresponding audio frame. The characteristics can include any audio characteristic, such as frequency, amplitude, duration, and/or the like.

Audio settings application 118 receives the audio scene type determined by audio scene analyzer 114 and the confidence score corresponding to the audio scene type. Audio settings application 118 then uses the determined audio scene type and the confidence score to select or adjusts audio parameters, such as equalizer settings, volume levels, and acoustic effects, tailored to enhance audio data 116 for the current audio segment. For example, for an audio scene type of dialogue, audio settings application 118 can select or adjust the audio parameters to emphasize speech clarity. For music audio scenes, audio settings application 118 enhances audio richness and depth. The audio settings are then provided to audio processing application 120.

Audio processing application 120 applies the adjustments determined by audio settings application 118 to the audio data 116. In various embodiments, audio processing application 120 use a variety of signal processing methods, such as Dynamic Range Compression (DRC) to maintain volume consistency across different audio scene types,

Equalization (EQ) to tailor frequency response to the specific needs of a dialogue audio scene type or music audio scene type segments, and/or the like. In some embodiments, for immersive experiences, audio processing application 120 includes 3D audio processing techniques, such as binaural rendering and/or the like, to create a three-dimensional sound stage.

### Audio Scene Determination via Audio Scene Analysis

FIG. 2 is a block diagram of audio scene analyzer 114 processing audio data 116, in accordance with various embodiments. As illustrated, audio scene analyzer 114 includes, without limitation, an audio segmentation module 200, a feature extraction module 202, a silence detector 206, an audio type classifier, and a contextual scene detector 214.

Audio segmentation module 200 divides the audio data 116 into segments or frames for further analysis. Audio segmentation module 200 segments the audio data 116 into fixed-length audio frames. In some examples, each audio frame is 0.48 seconds in duration. In various embodiments, each frame overlaps a previous audio frame and a following audio frame by a predetermined amount. For example, the predetermined amount can be 50% so that each portion of the audio data 116 is included in two audio frames. By overlapping consecutive frames, audio segmentation module 200 captures transitional elements in audio data 116 that can be missed with non-overlapping segmentation. For example, in a scenario where a scene transitions from a quiet dialogue to a sudden loud explosion, with non-overlapping segmentation in audio segmentation module 200, there is a risk of either segment being incorrectly classified, potentially missing the subtle change in audio data that precedes the explosion or the immediate aftermath of the dialogue.

Feature extraction module 202 receives the audio frames from audio segmentation module 200 and extracts features 204 for each of the audio frames. In various embodiments, feature extraction module 202 uses signal processing techniques to extract features, such as the frequency spectrum and/or the like, which provides insight into the pitch and harmonic content of the segments of audio data 116. In some embodiments, feature extraction module 202 extracts temporal features, such as the energy envelope, zero-crossing rate, and/or the like, which offer information about the rhythm and dynamics of the audio segments. For example, feature extraction module 202 can extract Mel-Frequency Cepstral Coefficients (MFCCs), which are effective for capturing the timbral qualities of each audio frame, feature extraction module 202 can extract features, such as spectral flux or beat histograms to capture the changing energy and rhythmic patterns of each audio frame. The extracted features 204 are then provided to the silence detector 206 and audio type classifier 210.

Silence detector 206 analyzes the extracted features 204 for each audio frame to determine whether there is an absence of significant acoustic activity to detect audio frames corresponding to silence. In various embodiments, silence detector 206 uses signal processing methods to detect silence scenes, such as analyzing the energy envelope of the audio frames, for example, calculated by squaring the amplitude values of the spectrum of the audio signal, averaging the squared values over the audio frame, and then taking the square root of the average. Silence detector 206 then classifies the audio frames with an energy envelope level below a certain threshold as silence. In some embodiments, silence detector 206 includes analysis of zero crossing rates, in which silence detector 206 assesses the flatness of the audio spectrum. For silent or near-silent audio frames, the spectrum tends to be flat, indicating a lack of distinct frequencies that characterize non-silent audio. Moreover, in at least one embodiment, silence detector 206 uses statistical analysis, in which silence detector 206 analyzes the statistical distribution of the amplitudes within a frame. Silent frames often have a very narrow distribution located near zero. In various embodiments, silence detector 206 uses machine learning methods trained on a variety of features, not limited to energy-based features, to differentiate between silent and non-silent audio frames.

In various embodiments, silence detector 206 includes machine learning techniques to detect audio frames corresponding to silence. In some embodiments, silence detector 206 uses supervised learning algorithms, where machine learning models are trained on a dataset labeled with ‘silence’ and ‘non-silence’ audio segments, to learn the characteristics of silence scene types in various contexts. For example, silence detector 206 can include a Support Vector Machine (SVM) which is trained to recognize the distinct boundaries between silence and sound by identifying the optimal hyperplane within the space of extracted features 204. Alternatively, in some embodiments, silence detector 206 uses a neural network, such as a Recurrent Neural Network (RNN) with Long Short-Term Memory (LSTM) cells and/or the like, to predict silence in audio sequences by learning the temporal patterns that typically precede and follow silent intervals. Moreover, in various embodiments, silence detector 206 uses anomaly detection methods, where any deviation from the norm (typical sound patterns) is detected to correspond to silence.

Silence detector 206 then generates a silence prediction 208 for each audio frame based on the analysis of extracted features 204. The silence predictions 208 are then provided to contextual scene detector 214.

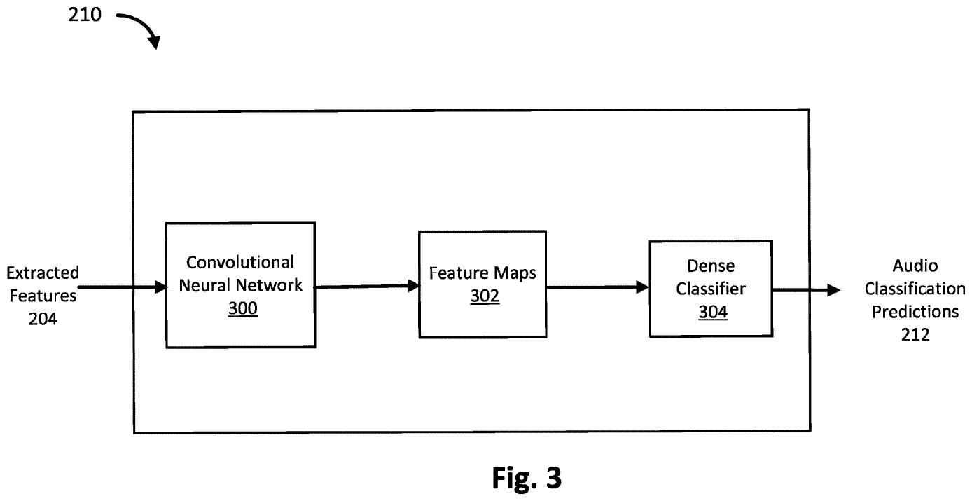

Audio type classifier 210 processes extracted features 204 to classify audio scene types within each audio frame as illustrated in more detail in FIG. 3. In various embodiments, audio type classifier 210 uses various classification algorithms to classify various audio scene types, such as speech, music, dialogue, silence, and/or the like. In various embodiments, audio type classifier 210 uses machine learning techniques, such as Decision Trees to make initial judgments based on the extracted features 204, or Deep Neural Networks (DNNs) that can learn from large datasets and make more nuanced distinctions between audio scene types. For example, the machine learning techniques can be trained on Google Audioset Strong dataset, which was created for solving audio tagging tasks with noisy audio type labels, human vocal sounds, which are of dialogue audio type, SESA gunshot/gunfire audio dataset, which are of action audio type, condensed movie dataset, which can be added to add real movie scenes which contains mixed audio type contents, CommoVoice dataset, which are of dialogue audio type, FMA-SMALL and GTZAN datasets, which are of music audio type, live music dataset, which are of music audio type with crowd noise, live sports commentary dataset, which are of are of mixed action and dialogue audio types, and synthetically generated dataset, in which dialogue, action or music audio types are synthetically mixed with different signal-to-noise ratios to generate different mixed audio scene scenarios. In some embodiments, audio type classifier 210 uses Gaussian Mixture Models (GMMs) to identify the probabilistic features of speech. In some embodiments, when dealing with music audio scene types, audio type classifier 210 uses a Convolutional Neural Network (CNN) to recognize patterns that are indicative of musical structures. In some embodiments, audio type classifier 210 uses Random Forests, which can handle the variability of non-speech audio scene types by considering a multitude of decision trees. The audio scene types classified by audio type classifier 210 are provided as audio classification predictions 212 contextual scene detector 214.

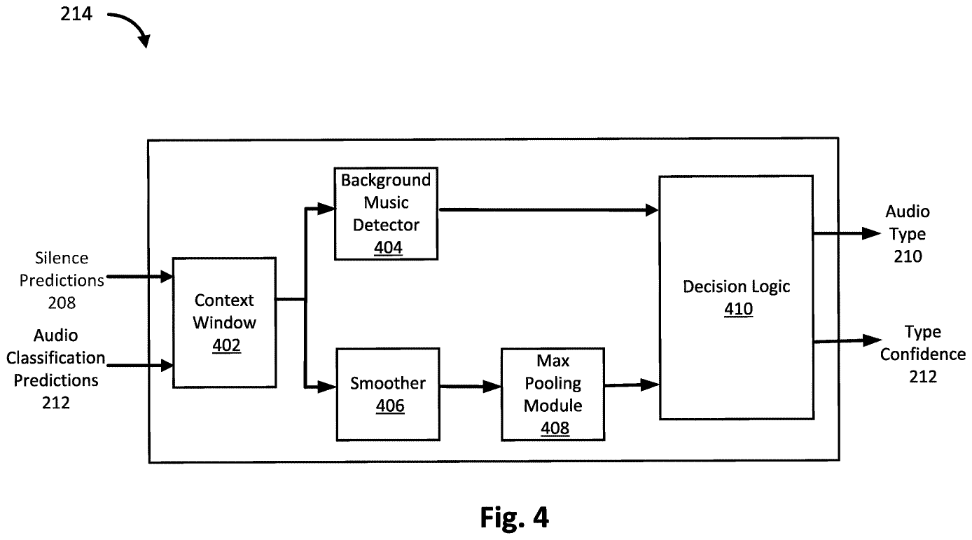

Contextual scene detector 214 processes a history of silence predictions 208 and audio classification predictions 212 to determine the audio type 216 and the corresponding type confidence 218 for each of the audio frames. Contextual scene detector 214 is described in further detail in FIG. 4

FIG. 3 is a block diagram of audio type classifier 210 included in audio scene analyzer 114 processing extracted features 204, according to various embodiments. As illustrated, audio type classifier 210 includes, without limitation, a convolutional neural network (CNN) 300, a set of feature maps 302, and a dense classifier 304.

CNN 300 analyzes extracted features 204 for an audio segment, such as Mel Spectrograms and/or the like, and constructs a set of feature maps 302. CNN 300 applies multiple layers of filters to detect patterns in the frequency and time domains the extracted features 204. In various embodiments, initial layers of CNN 300 identify basic patterns such as the edges of sound bursts, while deeper layers detect more complex features, such as the texture of sound to differentiate between various audio scenes and/or the like.

In some embodiments, CNN 300 includes the MobileNetV1 architecture known for computational efficiency on mobile devices. MobileNetV1 processes the extracted features 204 to identify patterns that can be used to classify audio scene types. In some embodiments, CNN 300 includes frozen layers, whose weights have been kept constant during the retraining process. Frozen layers can speed up training and leverage previously learned features that are still relevant for the classification of a new audio frame.

Feature maps 302 are generated by CNN 300. Each feature map 302 corresponds to a specific filter applied by CNN 300, highlighting distinct aspects of extracted features 204. For example, one feature map 302 can emphasize the boundaries of different sounds by capturing sharp changes in frequency spectrum, which are common at the start or end of a musical note or a spoken word. Another feature map 302 can focus on sustained frequencies, identifying the steady hum of a machine or the continuous note in a song. The feature maps 302 collectively represent a set of attributes extracted from extracted features 204, such as texture, intensity, and temporal changes, which are used by dense classifier 304.

Dense classifier 304 receives the set of attributes from feature maps 302 and classifies the audio data 116 into different audio scene types, such as music, action, dialogue, and/or the like. In various embodiments, dense classifier 304 includes one or more densely connected neural network layers that can make distinctions between different audio scene types. For example, dense classifier 304 can identify an audio scene type as music if the features from feature maps 302 indicate a harmonic structure and rhythmic consistency, or as dialogue if the features from feature maps 302 suggest clear patterns of human vocal frequencies and speech cadence. Dense classifier 304 outputs audio classification predictions 212.

FIG. 4 is a block diagram of contextual scene detector 214 of audio scene analyzer 114, according to various embodiments. As shown, contextual scene detector 214 includes, without limitation, a context window 402, a background music detector 404, a smoother 406, a max pooling module 408, and decision logic 410.

Context window 402 includes silence predictions 208 and audio classification predictions 212 for a specific number of consecutive audio frames denoted by C, for example C can be 2, 3, 4, or more depending on how long the context is considered during audio scene analysis. For example, for a frame length of 0.5 seconds, if the context window 402 at time index T corresponding to the time 3 seconds is set to include five audio frames C=5, the context window 402 includes five audio frames together corresponding to time periods (1.5 s, 2.0 s), (1.75 s, 2.25 s), (2.0 s, 2.5 s), (2.25 s, 2.75 s) and (2.5 s, 3.0 s), when a 50% audio frame overlap is used.

Background music detector 404 determines the presence of background music within an audio frame. In various embodiments, background music detector 404 computes the sum of absolute gradients of the confidence levels for music audio scene across audio frames held by the context window 402 of size C according to Equation 1.

$$S = {\sum }_{i = ( T - C )}^{( T )} \vert confidence [ i ] - confidence [ i + 1 ] \vert \qquad Equation 1$$

where S is the sum of absolute differences in confidence scores, confidence [i] is the music audio scene detection confidence score for the i^{th} audio frame, T is the index of the current audio frame, and C is the size of the context window. If S exceeds a predefined background music threshold ranging between 0.1 to 0.5 background music detector 404 classifies the current audio frame as containing background music by setting a BGM flag to 1, signaling that the audio scene should be processed with considerations for the underlying background music content. For example, with a context window size C of 5 audio frames and the frame length of 0.5 seconds, background music detector 404 receives confidence scores for music audio scene detection as Confidences=[0.1,0.15,0.2,0.25,0.3], then, background music detector 404 calculates the sum of absolute gradients(S) by summing up the absolute differences between successive confidence scores:

S=|0.1−0.15|+|0.15−0.2|+|0.2−0.25|+|0.25−0.3|

S=0.05+0.05+0.05+0.05+0.05

S=0.25

If the background music threshold is predefined to be 0.2, and the computed sum S of 0.25 is greater than 0.2, background music detector 404 will indicate the presence of background music by setting the BGM flag to 1. The gradient computation allows background music detector 404 to detect the emergence or consistency of musical elements over time, in contrast to transient musical sounds that do not correspond to background music.

Smoother 406 uses a time-based decay function to moderate fluctuations in the confidence scores over a specific window. The window is defined by a parameter: M, the duration of the smoothing window, for example, M can be 2, 3, 4, or more. In various embodiments, smoother 406 includes a linear decay weight function, with weights wᵢ, which proportionally reduce the influence of audio frames based on the index distance from the current frame T. For example, the formula for calculating the weight of each audio frame i can be described as in Equation 2.

$${w}_{i} = M ( 1 - \frac{i}{M} ) \qquad Equation 2$$

where wᵢ is the weight applied to the i^{th} audio frame's confidence, i is the index of the audio frame within the context window, T is the index of the current audio frame, M represents the number of the audio frames used in smoothing. The linear decay weighting ensures that recent audio frames have more influence on the smoothed confidence score, while the impact of audio frames further away in time is progressively reduced. In various embodiments, the output audio frame confidences from smoother 406 are normalized to avoid audio frame confidences that are greater than one. Alternatively, other non-linear decay functions can be used.

Max pooling module 408 extracts the most prominent audio type from the set of smoothed audio frame confidences provided by smoother 406 for each audio frame. By identifying the audio frame type with the maximum confidence within each audio frame, max pooling module 408 determines the most significant audio characteristic present in that audio frame. The operation of max pooling in max pooling module 408 can be mathematically represented as shown in Equation 3.

Max_Confidence[i]=max(smoothed_confidence[i]) Equation 3

where Max_Confidence[i] is the maximum confidence selected by the module at audio frame index i and smoothed_confidences is the array of confidences that have been smoothed by smoother 406. By using max pooling in max pooling module 408, transient or less significant audio features are not allowed to disproportionately influence the audio scene type determination.

Decision logic 410 determines the audio scene type and the corresponding confidence level. In various embodiments, decision logic 410 calculates the percentage duration of each audio type denoted by % Type, where Type can be any audio type, such as action, dialogue, music, silence, and/or the like, within the output of max pooling module 408 over a pooling window denoted by N in terms of number of audio frames, and computes the confidence of each audio type as the average of confidences Confidence_{type}. Decision logic 410 decides based on several preset parameters Type_{Threshold}. For example, Action_{Threshold}=50%, Dialogue_{Threshold}=50%, Music_{Threshold}=70%, and Silence_{Threshold}=50%. Then, for every audio type, decision logic 410 computes % Type−Type_{Threshold} and identifies the dominant audio type Type* as the audio type that corresponds to the highest value of % Type-Type_{Threshold}.

In various embodiments, after determining the dominant audio type, the decision logic 410 determines audio type 216 and type confidence 218 based on a set of heuristic rules. In at least one embodiment, decision logic 410 uses the following heuristic rules to determine audio type 216 and type confidence 218. If the output of background music detector 404 is BGM=0 indicating no background music, decision logic 410 outputs the dominant audio type Type*as audio type 216 with type confidence 218 as Confidence_{type*}. If BGM=1 indicating the presence of background music and if Confidence_{Action} or Confidence_{Dialogue} is greater than 0.4, the decision logic 410 outputs the audio type (action or dialogue) corresponding to the higher confidence value as audio type 216 with the corresponding type confidence 218; however, if the confidence values are below 0.1, decision logic 410 outputs music as the audio type 216. If Type* is silence, decision logic 410 outputs the audio type 216 of the previous frame with type confidence 218 set to zero. If Type* is not silence and % Type*−Type*_{threshold} is negative, decision logic 410 outputs the Type* in the previous audio frame as audio type 216 with type confidence 218 set to Confidence_{type*}.

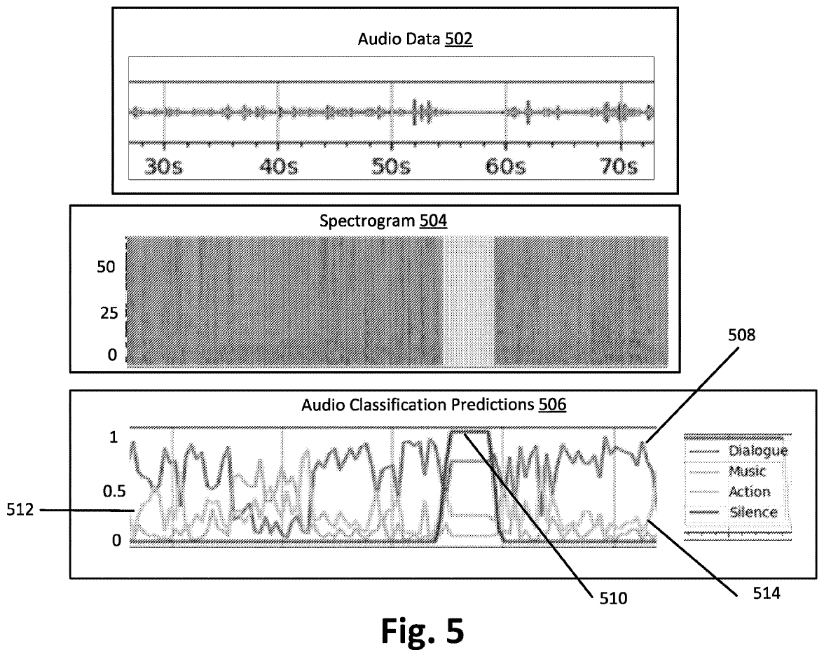

FIG. 5 illustrates an example of audio data 502 that is analyzed, according to various embodiments. As shown, audio data 502 depicts an amplitude of the audio input over time. Spectrogram 504 depicts the frequency spectrum as the audio input varies with time, in which brighter areas represent silence or lower energy sounds, while darker areas indicate more intense sounds. After processing by audio segmentation module 200 and feature extraction module 202, audio data 502 is classified by audio type classifier 210 and silence detector 206 to determine an audio type of each audio frame in audio data 502 as shown by audio classification predictions 506. The audio classification predictions 506 show the confidence assigned to each classified audio type determined by audio type classifier 210 and silence detector 206 over the same timeline as the audio data 502 and spectrogram 504. Each line shows the audio classification prediction for a different audio type, such as dialogue 508, music 512, action 514, and silence 510. The unsmoothed audio classification predictions 506 indicated the initial assessment of the likelihood that each audio frame includes audio of the indicated type when each of the audio frames are considered separately. Further processing of the audio classification predictions 506 is then performed by contextual scene detector 214 to determine audio type 216 and type confidence 218 for each audio frame by considering the audio classification probabilities over multiple audio frames.

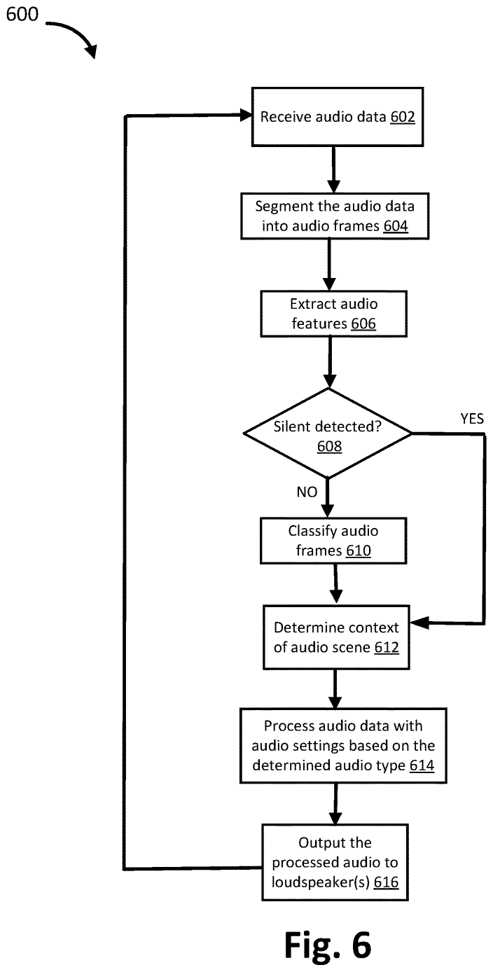

FIG. 6 is a flow diagram of method steps for analyzing audio scenes, according to various embodiments. Although the method steps are described in conjunction with the systems of FIGS. 1-4, persons skilled in the art will understand that any system configured to perform the method steps, in any order, falls within the scope of the present disclosure.

The method 600 begins at step 602, where the computing device 102 receives audio data 116. In some examples, the audio input is received via the I/O interface 106 as part of streaming media or is loaded from memory 112. For example, the audio input can correspond to the sound track of a movie being viewed by the user. The audio input is stored in memory 112 as audio data 116.

At step 604, audio segmentation module 200 segments audio data 116 into audio frames. Audio data 116 is segmented into fixed length audio frames. In various embodiments, consecutive audio frames overlap, for example, by 50%. For example, if the fixed length of each audio frame is set to 0.5 seconds, the audio segmentation module 200 creates audio frames such that each begins halfway through the preceding audio frame. The first audio frame then covers audio data 116 from 0 to 0.5 seconds, the second from 0.25 to 0.75 seconds, and so forth, creating a continuous and overlapping sequence of audio frames. As soon as audio segmentation module 200 receives enough audio data 116 for a new audio frame, audio segmentation module 200 passes the audio frame to feature extraction module 200.

At step 606, feature extraction module 202 extracts audio features 204 from the audio frame received from audio segmentation module 200. In various embodiments, feature extraction module 202 analyzes the audio frame to identify and derive acoustic characteristics used for subsequent classification, such as spectral features including but not limited to MFCCs, spectral centroid, spectral flux, and spectral roll-off, temporal features, which capture the time-based characteristics of sound, such as zero-crossing rate (the rate at which the audio frame signal changes sign), or temporal envelope characteristics that track the changes in audio frame signal amplitude over time, and harmonic features including but not limited to harmonics-to-noise ratio or pitch.

At step 608, silence detector 206 analyzes the extracted features 204 in the audio frame to determine whether the audio frame should be classified as silence. In various embodiments, silence detector 206 calculates the energy envelope of the audio frame by taking the root mean square (RMS) of the amplitude values within the audio frame, providing a single value representing the power of the signal within the audio frame. If the energy envelope value falls below a pre-set threshold, silence detector 206 concludes that the audio frame should be classified as silence. In some embodiments, silence detector 206 checks the zero crossing rate, which indicates how frequently the audio frame signal changes sign or crosses the zero amplitude axis. If the zero crossing rate is below a threshold, silence detector 206 concludes that the audio frame should be classified as silence. Silence detector 206 outputs a silence prediction 208, which, in some embodiments, is a binary flag indicating the presence or the absence of silence with values of 1 or 0, respectively, in the audio frame. If silence is detected in the audio frame, method 600 proceeds to step 612. Otherwise, method 600 proceeds to step 610.

At step 610, audio type classifier 210 classifies the audio frame. Audio type classifier 210 analyzes the extracted features in the audio frame to generate audio types 212. The audio classification predictions 212 indicate the probabilities that each of one or more sound types (e.g., dialogue, music, silence, action, etc.) is present in the audio frame. In various embodiments, audio type classifier 210 uses machine learning techniques to generate audio classification predictions 212.

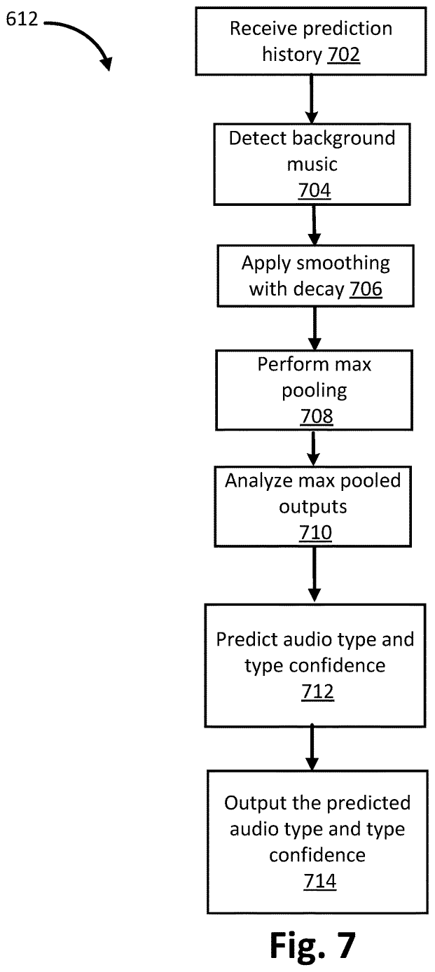

At step 612, contextual scene detector 214 determines the context of the audio scene in the audio frame. Contextual scene detector 214 analyzes silence predictions 208 from step 608 and audio classification predictions 212 from step 610 and outputs the context of the audio scene using audio type 216 and type confidence 218. Step 612 is described in more detail in FIG. 7.

At step 614, audio processing application 120 processes audio data 116 with audio settings based on the determined audio type 216. Audio settings application 118 selects and modifies the audio settings based on the audio type 216 and type confidence 218 generated during step 612. The audio settings can include one or more of equalizer settings, volume levels, acoustic effects, and/or the like, to enhance the determined audio type. For example, audio settings application 118 can set the audio settings to increase the treble to enhance speech clarity in an audio frame with dialogue or boost the bass for a richer and deeper musical experience in an audio frame with music. Audio processing application 120 then uses the audio settings to process audio data 116. Audio processing application 120 then adjusts the audio data 116 in the audio frame using the audio settings. This adjusts the audio data 116 in real time to improve the audio listening experience by enhancing the audio data 116 based on the overall audio scene in the audio frame while accounting for the context of previous audio frame.

At step 616, audio processing application 120 outputs the processed audio to loudspeaker(s) 104 of computing device 102. The loudspeaker(s) 106 convert the process audio data 116 into sound waves which are customized based on the audio type.

After completing step 616, the method loops back to step 602 to analyze additional audio inputs by repeating method 600. By repeating method 600, computing system 100 continues to dynamically update the audio settings used to process the audio inputs in real time to improve the listening experience.

FIG. 7 is a flow diagram of method steps corresponding to step 612 for determining the context of an audio scene, according to various embodiments. Although the method steps are described in conjunction with the systems of FIGS. 1-4, persons skilled in the art will understand that any system configured to perform the method steps, in any order, falls within the scope of the present disclosure.

At step 702, contextual scene detector 214 receives prediction history. The prediction history includes silence predictions 208 and audio classification predictions 212 over context window 402. Context window 402 includes a fixed number of audio frame predictions, which allows for a consideration of the temporal relationships and patterns that emerge over a series of audio frames.

At step 704, background music detector 404 determines whether background music is present by analyzing extracted features 204 across the audio frames included in context window 402. For example, background music detector 404 can sum the absolute differences in confidence levels for the music audio scene and then compares the sum to a threshold. If background music is detected, background music detector 404 sets the BGM flag to 1. Otherwise, the flag is set to 0.

At step 706, smoother 406 applies smoothing with decay to the confidence scores corresponding to the audio classification predictions 212 in context window 402. Smoother 406 computes applies a weight to the confidence scores for the current audio frame and the previous audio frames within context window based on a time-based decay function that provides weights from an initial value for the current audio frame and then decease in value or each previous frame. For example, smoother 406 can generate the weights according to Equation 2. In various embodiments, step 706 can be carried out before step 704 or in parallel with step 704.

At step 708, max pooling module 408 performs max pooling to the smoothed audio classification predictions 212 of the audio frames. The max pooling identifies the audio type corresponding to the highest smoothed classification prediction determined during step 706 for the audio frame.

At step 710, decision logic 410 analyzes the max pooled outputs over a fixed number of audio frames in a pooling window to determine the dominant audio type. Decision logic 410 determines dominant audio types by calculating the percentage duration and average classification probability of each audio type over the pooling window. Decision logic 410 then compares the average classification probabilities against predefined thresholds to identify the dominant audio type.

At step 712, decision logic 410 predicts audio type 216 and type confidence 218 for the audio frame. Decision logic 410 applies a set of heuristic rules to predict audio type 216 and type confidence 218. The heuristic rules consider multiple factors, including but not limited to the presence or absence of background music as identified by background music detector 404 in step 704, as well as the prevailing dominant audio type as determined at step 710. Furthermore, the heuristic rules consider previous audio type predictions, to predict the current audio type with more accuracy. For example, if silence is detected as the current dominant audio type, but previous audio type predictions suggest a recurring pattern of dialogue audio type or action audio type, decision logic 410 adjusts the current audio type prediction to align with the expected continuity of the audio type. The heuristic rules are designed to balance between the immediate audio features and the broader context established by past and present audio frames to ensure that transient sounds or momentary changes in audio type do not disproportionately skew the audio type prediction.

At step 714, decision logic 410 outputs the predicted audio type 216 and type confidence 218. The predicted audio type 216, such as music, dialogue, action, silence, and/or the like, and type confidence 218, which is the probability of accurate audio type classification ranging from 0 to 1, are then provided to audio settings application 118 to select and modify the audio settings in step 614.

In sum, the disclosed techniques dynamically analyze audio scenes based on content identification. Incoming audio content is segmented into audio frames. The audio frames are then analyzed to extract audio features. The audio frame is then classified to determine which of one or more audio types is present in the audio frame. The classification can include not only the identification of the audio type but also a confidence level indicating the classification certainty. The classification of the current audio frame and historical data from preceding audio frames are then analyzed to determine a current context of the audio scene. Once the audio type for the audio scene is determined, the audio settings for that audio type are selected. The audio content is then processed using the selected audio settings to generate audio that. is output using one or more speakers.

At least one technical advantage of the disclosed techniques relative to the prior art is that, with the disclosed techniques, automatic adaptation of audio settings for dynamically changing audio scenes are possible without metadata tagging. The techniques further allows for the changing of audio settings when it is impractical or unsafe for a user to adjust the audio settings in real time. The disclosed techniques further accurately classify complex audio scenes with multiple overlapping audio types, making contextually appropriate adjustments to enhance the overall listening experience without causing abrupt changes in the audio settings that would disrupt the listening experience. Further, the disclosed techniques smoothly transition into and out of periods of silence. These technical advantages provide one or more technological improvements over prior art approaches.
1. In some embodiments, a computer-implemented method for adjusting audio comprises receiving audio data, segmenting the audio data into a plurality of audio frames, extracting one or more audio features from the plurality of audio frames, classifying each of the plurality of audio frames to generate audio classification predictions for the plurality of audio frames based on the one or more features, determining an audio type for a current audio frame of the plurality of audio frames based on the audio classification predictions for the plurality of audio frames within a context window, determining one or more audio settings based on the audio type, processing the audio data for the current audio frame using the one or more audio settings, and outputting the processed audio data using one or more loudspeakers.
2. The computer-implemented method of clause 1, wherein the plurality of audio frames are overlapping audio frames.
3. The computer-implemented method of clauses 1 or 2, wherein the one or more audio features comprise at least one of temporal features or Mel-Frequency Cepstral Coefficients.
4. The computer-implemented method of any of clauses 1-3, wherein the audio classification predictions comprise predictions for one or more audio types selected from the group consisting of silence, dialogue, action, and music.
5. The computer-implemented method of any of clauses 1-4, wherein classifying each of the plurality of audio frames comprises applying one or more machine learning models.
6. The computer-implemented method of any of clauses 1-5, further comprising determining whether each audio frame in the plurality of audio frames includes silence based on an energy envelope or zero-crossings in each audio frame in the plurality of audio frames, and determining the audio type for the current audio frame based on whether the current audio frame includes silence.
7. The computer-implemented method of any of clauses 1-6, wherein determining the audio type for the current audio frame comprises weighting the audio classification predictions for the plurality of audio frames within the context window according to a time-based decay function, determining an audio type with a highest prediction in each of the plurality of audio frames within the context window, and applying one or heuristic rules to determine the audio type for the current audio frame.
8. The computer-implemented method of any of clauses 1-7, wherein determining the audio type for the current audio frame further comprises determining a percentage duration of each audio type over the context window, subtracting corresponding confidence thresholds for each audio type from the determined percentage durations, and applying the one or more heuristic rules based on results of the subtracting.
9. The computer-implemented method of any of clauses 1-8, wherein determining the audio type for the current audio frame further comprises determining an average of confidence scores for each audio type over the context window, and applying the one or more heuristic rules based on the averages of the confidence scores.
10. The computer-implemented method of any of clauses 1-9, wherein determining the audio type for the current audio frame further comprises detecting whether background music is present in the context window, and applying the one or more heuristic rules based on the background music detection.
11. The computer-implemented method of any of clauses 1-10, wherein detecting whether background music is present comprises computing a sum of gradients in confidence scores for the audio classification predictions corresponding to an audio type of music over the context window, and determining that background music is present when the sum is greater than a threshold.
12. The computer-implemented method of any of clauses 1-11, further comprising determining a confidence in the prediction of the audio type, and further determining the one or more audio settings based on the confidence in the prediction.
13. The computer-implemented method of any of clauses 1-12, wherein when the current audio frame is classified as silence determining the audio type for the current audio frame comprises setting the audio type to a preceding audio type of a first audio frame preceding the current audio frame, and setting a confidence of the audio type to zero.
14. In some embodiments, one or more non-transitory computer-readable media store instructions that, when executed by one or more processors, cause the one or more processors to perform the steps of receiving audio data, segmenting the audio data into a plurality of audio frames, extracting one or more audio features from the plurality of audio frames, classifying each of the plurality of audio frames to generate audio classification predictions for the plurality of audio frames based on the one or more features, determining an audio type for a current audio frame of the plurality of audio frames based on the audio classification predictions for the plurality of audio frames within a context window, determining one or more audio settings based on the audio type, processing the audio data for the current audio frame using the one or more audio settings, and outputting the processed audio data using one or more loudspeakers.
15. The one or more non-transitory computer-readable media of clause 14, wherein the plurality of audio frames are overlapping audio frames.
16. The one or more non-transitory computer-readable media of clauses 14 or 15, wherein the audio classification predictions comprise predictions for one or more audio types selected from the group consisting of silence, dialogue, action, and music.
17. The one or more non-transitory computer-readable media of any of clauses 14-16, wherein the steps further comprise determining whether each audio frame in the plurality of audio frames includes silence based on an energy envelope or zero-crossings in each audio frame in the plurality of audio frames, and determining the audio type for the current audio frame based on whether the current audio frame includes silence.
18. The one or more non-transitory computer-readable media of any of clauses 14-17, wherein determining the audio type for the current audio frame comprises weighting the audio classification predictions for the plurality of audio frames within the context window according to a time-based decay function, determining an audio type with a highest prediction in each of the plurality of audio frames within the context window, subtracting corresponding confidence thresholds for each audio type from the determined percentage durations, and applying one or more heuristic rules.
19. The one or more non-transitory computer-readable media of any of clauses 14-18, wherein determining the audio type for the current audio frame further comprises detecting whether background music is present in the context window, and applying the one or more heuristic rules based on the background music detection.
20. In some embodiments, a system comprises memory storing one or more instructions, and one or more processors that, when executing the one or more instructions, are configured to perform steps comprising receiving audio data, segmenting the audio data into a plurality of audio frames, extracting one or more audio features from the plurality of audio frames, classifying each of the plurality of audio frames to generate audio classification predictions for the plurality of audio frames based on the one or more features, determining an audio type for a current audio frame of the plurality of audio frames based on the audio classification predictions for the plurality of audio frames within a context window, determining one or more audio settings based on the audio type, processing the audio data for the current audio frame using the one or more audio settings, and outputting the processed audio data using one or more loudspeakers.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for adjusting audio, the method comprising:
receiving audio data;
segmenting the audio data into a plurality of audio frames;
extracting one or more audio features from the plurality of audio frames;
classifying each of the plurality of audio frames to generate audio classification predictions for the plurality of audio frames based on the one or more features;
determining an audio type for a current audio frame of the plurality of audio frames based on the audio classification predictions for the plurality of audio frames within a context window;
determining one or more audio settings based on the audio type;
processing the audio data for the current audio frame using the one or more audio settings; and
outputting the processed audio data using one or more loudspeakers.

2. The computer-implemented method of claim 1, wherein the plurality of audio frames are overlapping audio frames.

3. The computer-implemented method of claim 1, wherein the one or more audio features comprise at least one of temporal features or Mel-Frequency Cepstral Coefficients.

4. The computer-implemented method of claim 1, wherein the audio classification predictions comprise predictions for one or more audio types selected from the group consisting of: silence, dialogue, action, and music.

5. The computer-implemented method of claim 1, wherein classifying each of the plurality of audio frames comprises applying one or more machine learning models.

6. The computer-implemented method of claim 1, further comprising:
determining whether each audio frame in the plurality of audio frames includes silence based on an energy envelope or zero-crossings in each audio frame in the plurality of audio frames; and
determining the audio type for the current audio frame based on whether the current audio frame includes silence.

7. The computer-implemented method of claim 1, wherein determining the audio type for the current audio frame comprises:
weighting the audio classification predictions for the plurality of audio frames within the context window according to a time-based decay function;
determining an audio type with a highest prediction in each of the plurality of audio frames within the context window; and
applying one or heuristic rules to determine the audio type for the current audio frame.

8. The computer-implemented method of claim 7, wherein determining the audio type for the current audio frame further comprises:
determining a percentage duration of each audio type over the context window;
subtracting corresponding confidence thresholds for each audio type from the determined percentage durations; and
applying the one or more heuristic rules based on results of the subtracting.

9. The computer-implemented method of claim 8, wherein determining the audio type for the current audio frame further comprises:
determining an average of confidence scores for each audio type over the context window; and
applying the one or more heuristic rules based on the averages of the confidence scores.

10. The computer-implemented method of claim 7, wherein determining the audio type for the current audio frame further comprises:
detecting whether background music is present in the context window; and
applying the one or more heuristic rules based on the background music detection.

11. The computer-implemented method of claim 10, wherein detecting whether background music is present comprises:
computing a sum of gradients in confidence scores for the audio classification predictions corresponding to an audio type of music over the context window; and
determining that background music is present when the sum is greater than a threshold.

12. The computer-implemented method of claim 1, further comprising:
determining a confidence in the prediction of the audio type; and
further determining the one or more audio settings based on the confidence in the prediction.

13. The computer-implemented method of claim 1, wherein when the current audio frame is classified as silence:
determining the audio type for the current audio frame comprises setting the audio type to a preceding audio type of a first audio frame preceding the current audio frame; and
setting a confidence of the audio type to zero.

14. One or more non-transitory computer-readable media storing instructions that, when executed by one or more processors, cause the one or more processors to perform the steps of:
receiving audio data;
segmenting the audio data into a plurality of audio frames;
extracting one or more audio features from the plurality of audio frames;
classifying each of the plurality of audio frames to generate audio classification predictions for the plurality of audio frames based on the one or more features;
determining an audio type for a current audio frame of the plurality of audio frames based on the audio classification predictions for the plurality of audio frames within a context window;
determining one or more audio settings based on the audio type;
processing the audio data for the current audio frame using the one or more audio settings; and
outputting the processed audio data using one or more loudspeakers.

15. The one or more non-transitory computer-readable media of claim 14, wherein the plurality of audio frames are overlapping audio frames.

16. The one or more non-transitory computer-readable media of claim 14, wherein the audio classification predictions comprise predictions for one or more audio types selected from the group consisting of: silence, dialogue, action, and music.

17. The one or more non-transitory computer-readable media of claim 14, wherein the steps further comprise:
determining whether each audio frame in the plurality of audio frames includes silence based on an energy envelope or zero-crossings in each audio frame in the plurality of audio frames; and
determining the audio type for the current audio frame based on whether the current audio frame includes silence.

18. The one or more non-transitory computer-readable media of claim 14, wherein determining the audio type for the current audio frame comprises:
weighting the audio classification predictions for the plurality of audio frames within the context window according to a time-based decay function;
determining an audio type with a highest prediction in each of the plurality of audio frames within the context window;
subtracting corresponding confidence thresholds for each audio type from the determined percentage durations; and
applying one or more heuristic rules.

19. The one or more non-transitory computer-readable media of claim 18, wherein determining the audio type for the current audio frame further comprises:
detecting whether background music is present in the context window; and
applying the one or more heuristic rules based on the background music detection.

20. A system comprising:
memory storing one or more instructions; and
one or more processors that, when executing the one or more instructions, are configured to perform steps comprising:
receiving audio data;
segmenting the audio data into a plurality of audio frames;
extracting one or more audio features from the plurality of audio frames;
classifying each of the plurality of audio frames to generate audio classification predictions for the plurality of audio frames based on the one or more features;
determining an audio type for a current audio frame of the plurality of audio frames based on the audio classification predictions for the plurality of audio frames within a context window;
determining one or more audio settings based on the audio type;
processing the audio data for the current audio frame using the one or more audio settings; and
outputting the processed audio data using one or more loudspeakers.
